(19) United States
(12) Patent Application Publication
(10) Pub. No.: US 2015/0151368 A1
(43) Pub. Date: Jun. 4, 2015

(54) METHOD AND HANDHELD APPARATUS FOR CUTTING METALS

(71) Applicants: Itzhak Nissani, Kfar Saba (IL); Yaniv Nissani, Kfar Saba (IL)

(72) Inventors: Itzhak Nissani, Kfar Saba (IL); Yaniv Nissani, Kfar Saba (IL)

(21) Appl. No.: 14/538,134

(22) Filed: Nov. 11, 2014

(30) Foreign Application Priority Data
Dec. 2, 2013 (IL) IL 229754

(51) Int. Cl. B23D 29/02

(52) U.S. Cl. CPC B23D 29/02

(57) ABSTRACT

A handheld apparatus for cutting metals, comprising: a first blade (28), shaped complementary to the shape of a cavity of a metal profile (10) to be cut, for placing the first blade (28) within the cavity, and maintaining a position of the placing during the cutting; at least a second blade (12), disposed against the first blade (28), for allowing moving the at least second blade (12) against the first blade (28) and against the metal profile (10) placed therewithin; a first handle (14) for holding the first blade (28); and a second handle (16), for moving the at least second blade (12), in relation to the first blade (28) and in relation to the metal profile (10); thereby moving the blades (12, 28) one against the other, while the first blade (28) supports the metal profile (10); thereby cutting the metal profile (10).

### CROSS-REFERENCE TO RELATED APPLICATIONS

This application claims priority to and benefit of the following patent application: (1) Israeli Application IL229754, filed Dec. 2, 2013 which is hereby incorporated by reference in its entirety as if fully set forth herein.

### TECHNICAL FIELD

The present invention relates to the field of cutting metals. More particularly, the invention relates to a method and apparatus for cutting metal profiles.

### BACKGROUND ART

Metal profiles are used in drywall construction to support the building of gypsum or plaster surfaces. Metal profiles are shaped in different profile forms designed for increase in material strength while avoiding additional weight. Regularly, metal profiles for the use of constructing drywalls are made from pre-galvanized steel. Some standards have developed for the manufacturing of metal profiles for drywalls, both relating to materials and to shapes.

A metal profile is used as a structure material, formed with a specific shape or cross-section, and certain standards of chemical composition and mechanical properties. It is customary to manufacture metal profiles for drywall construction in lengths of 2.6 meters to 3 meters, and some even longer.

Regarding some widespread standard materials used for such metal profiles, BS 2989: steel grade Z2, zinc coating type G275, ASTM A653M-G90, DIN EN 10147, among many others can be named.

Metal profiles are cut with tin snips (also known as tinner's snips), from one flange to the other. In order to fit a metal profile to the right size for constructing drywalls, it is customary to cut a profile with snips. Tinner's snips, tinner snips, or tin snips, are one of the most popular type of snips. Tin snips are defined by their long handles and short blades. They usually have extra wide jaws, and are made of drop forged carbon steel. Depending on the size of the blade, tin snips can cut between 23 and 16 gauge cold rolled low-carbon tin. Tin snips can be ranged in length from 7 to 14 inches (180 to 360 mm) in length. There are two main types of tin snips: straight-pattern and duckbill-pattern. Straight-pattern tin snips are better for straight cuts. Duckbill-pattern tin snips (also known as Trojan-pattern snips) have blades that taper down from the pivot to the tip of the blades, for an easier cut of curves or edges.

Another type of snips for cutting metal profiles for the use of constructing drywalls is the compound-action snips (also known as aviation snips, because they were developed to cut aluminum in the construction of an aircraft). Compound-action snips can cut up to 18 gauge aluminum, up to 24 gauge mild steel, and up to 26 gauge stainless steel. These types of snips have become the most popular because of the linkage that increases the mechanical advantage without increasing the length of the snips. There are three cutting styles: straight cutting, left cutting, and right cutting. Straight cutting snips cut in a straight line; left cutting snips cut straight and in a tight curve to the left; and right cutting snips cut straight and in a tight curve to the right. These different cutting styles are necessary when cutting around a curve.

The cutting of metal profiles with tin snips is far from ideal, and there is a great difficulty in cutting a profile in a straight line. Moreover, while cutting profiles, the relatively short blades of tin snips sometimes cause material slippage. This can cause a less than smooth operation of the tin snips, possibly resulting in distorted lines and protuberances.

The cutting of a metal profile with snips is a very complex task for unskilled workers, and even experienced workers find it difficult to cut around the three planes of a profile, having to switch the cutting direction along each right angle, to cut in a different plane. Cutting around the three planes of a profile by an unskilled worker may sometimes result in a twisted edge, and it is very difficult to follow a straight line along all the different planes of the profile.

Rough cutting lines of snips impose the risk of injuries for the workers in the construction site, resulting from the sharp protuberances and sharp edges of the cut profiles.

It is not easy to cut a metal profile in a straight line with snips, and elaborate labor is needed to cut through the right angles of the metal profile. While cutting around the different planes of the profile, the transfer point from one plane to another with the tin snips is strenuous and may result in a shift to a different cutting line, or in a disconnection between cutting points. In the latter case, the resulting uneven cut is not only unaesthetic, but may also result in the inaccuracy of a measurement.

A special difficulty arises when there is a need to cut the metal profile in a diagonal line, to allow for an angular connection of two profiles together (a miter joint). In this case, the diagonal cut of the profile will require a very skilled worker, experienced in cutting a profile in a diagonal line through its different planes.

All the methods described above have not yet provided satisfactory solutions to the problem of cutting metal profiles.

It is an object of the present invention to provide a method and apparatus for cutting profiles.

It is another object of the present invention to provide a method and apparatus for cutting metal profiles made from relatively thick metal.

It is a further object of the present invention to provide a method and apparatus for cutting a metal profile in a straight line.

It is a still further object of the present invention to provide a method and apparatus for cutting a metal profile in a diagonal line.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to an apparatus for cutting metals, comprising:
a first blade (28), shaped complementary to the shape of a cavity of a metal profile (10) to be cut, for placing the first blade (28) within the cavity;
at least a second blade (12), disposed against the first blade (28), for allowing moving the at least second blade (12) against the first blade (28);
a first handle (14) for holding the first blade (28); and
a motion mechanism (16, 38), for moving the at least second blade (12), in relation to the first blade (28);
   thereby moving the blades (12, 28) one against the other, while the first blade (28) supports the metal profile (10);
   thereby cutting the metal profile (10).

The motion mechanism (16, 38), for moving the at least second blade (12), in relation to the first blade (28) may comprise a second handle (16), thereby by moving the handles (14, 16) one towards the other, the blades (12, 28) move one against the other, while the first blade (28) supports the metal profile (10).

The at least second blade may comprise at least two blades (12A, 12B), each disposed against the first blade (28), for allowing moving the at least two blades (12A, 12B) against the first blade (28).

The apparatus for cutting metals may further comprise: a ratchet mechanism, for allowing a motion only in one direction, while preventing motion in the opposite direction.

The ratchet mechanism may comprise a gear (26) and a pawl (30) attached to a spring (32), thereby allowing a continuous rotary motion of the gear (26) in only one direction.

The gear (26) may be connected to the at least second blade (12), thereby allowing a motion of the at least second blade (12) only toward the direction of the first blade (28), while preventing a motion in the opposite direction.

The apparatus may further comprise a pinion (24) meshed with the gear (26), thereby transmitting torque from the pinion (24) to the gear (26) for allowing an increase in the mechanical force applied on the blades (28, 12), thereby increasing the power of cutting the metal profile (10).

The first blade (28) may be replaceable for being adapted to various profile shapes.

The shape of the first blade (28) may be adapted to comply with a selected standard shape of profile.

The shape of the first blade (28) may be adapted to comply with a selected angle of positioning thereof within the profile, thereby allowing diagonal cutting of the profile.

The apparatus for cutting metals may further comprise: a transmission mechanism (36), connected to the motion mechanism (16, 38) and to at least one of the at least two blades (12A, 12B), the transmission mechanism (36) for transmitting motion therebetween, thereby moving the at least one of the at least two blades (12A, 12B) in relation to the first blade (28).

The motion mechanism (16, 38) may comprise a motor (38), for moving at least one of the blades (12, 28) in relation to the other blade (12, 28).

The motor may be selected from a group consisting of: an electric motor, a hydraulic motor, and a pneumatic motor.

In another aspect, the present invention is directed to a method for cutting metals, comprising the steps of:
inserting a first blade (28) into a cavity of a metal profile (10), the first blade shaped complementary to the shape of the cavity of a metal profile (10) to be cut;
moving a first handle (14) and a second handle (16) one toward the other, for moving the first blade (28) toward a second blade (12), placed against the first blade (28);
   thereby the second blade (12) moves against the first blade (28) while the first blade supports the metal profile (10), thereby cutting the metal profile (10).

The method may further comprise the step of: repeating the step of moving the first handle (14) and the second handle (16) one toward the other, wherein in each time releasing the handles (14, 16) and then pressing on the handles (14, 16) again; wherein a ratchet mechanism allows a motion of the second blade (12) only toward the direction of the first blade (28) while preventing a motion in the opposite direction, thereby moving the blades (12, 28) one against the other in only one direction.

The step of inserting the first blade (28) within the cavity of the metal profile (10) may comprise the step of: placing the first blade (28) diagonally to the metal profile (10); thereby the cutting of the metal profile (10) may comprise cutting the metal profile (10) in a diagonal line.

The diagonal placing of the first blade (28) in relation to the metal profile (10) may comprise an angle of 45 degrees, thereby the cutting of the metal profile (10) may comprise cutting the metal profile (10) at an angle of 45 degrees, thereby enabling to connect the cut metal profile (10) in a miter joint with another metal profile.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Preferred embodiments, features, aspects and advantages of the present invention are described herein in conjunction with the following drawings:

FIG. 1 is a schematic illustration of an apparatus for cutting metals, according to one embodiment of the present invention.

FIG. 2 is a schematic illustration of cutting a metal profile, according to one embodiment of the present invention.

FIG. 3 is a schematic illustration of an apparatus for cutting metals with a ratchet mechanism, according to one embodiment of the present invention.

FIG. 4 is a schematic illustration of cutting a metal profile, according to one embodiment of the present invention.

FIG. 5 is a schematic illustration of cutting a metal profile, according to one embodiment of the present invention.

FIG. 6 is a schematic illustration of a metal profile cut into two parts with an apparatus for cutting metals, according to one embodiment of the present invention.

FIG. 7 is a schematic illustration of cutting a profile in a diagonal line with an apparatus for cutting metal profiles, according to another embodiment of the present invention.

FIG. 8 is a schematic illustration of an apparatus for cutting metals with three blades, according to another embodiment of the present invention.

FIG. 9 is a schematic illustration of an apparatus for cutting metals coupled with a motor, according to one embodiment of the present invention.

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

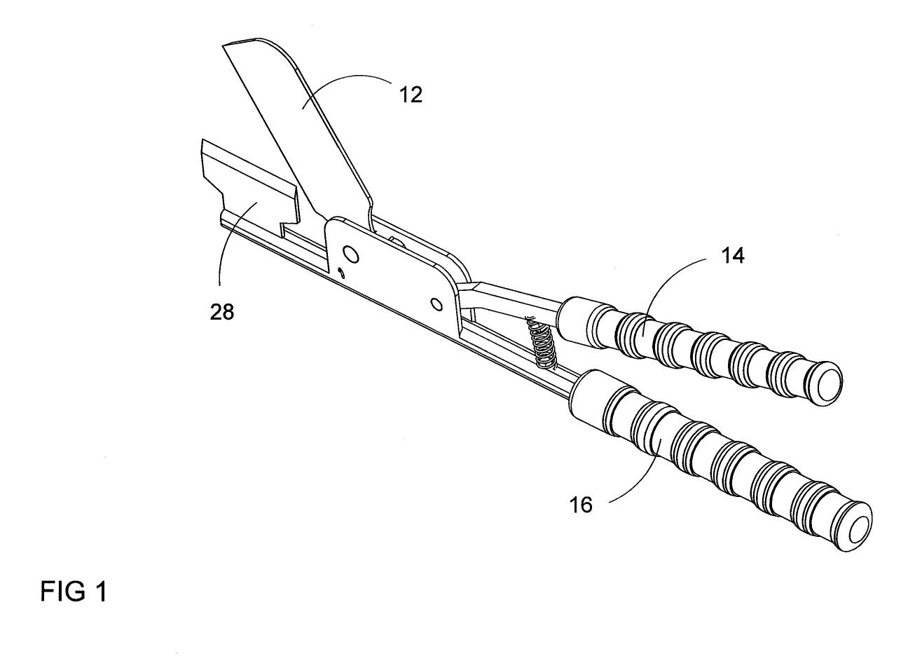

FIG. 1 is a schematic illustration of an apparatus for cutting metals, according to one embodiment of the present invention.

According to one embodiment of the present invention, an apparatus for cutting metals has an upper blade 12 (“second blade”), and a lower profile blade 28 (“first blade”), for cutting metals. A first handle 14 and a second handle 16 are used for closing the opposite blades 12 and 28 to make the cut. The upper blade 12 and profile blade 28 are drawing nearer as they move against each other, when the first handle 14 and second handle 16 are closed.

According to one embodiment of the present invention, by closing first handle 14 and second handle 16, a user can cut a metal profile as the upper blade 12 and the profile blade 28 pass each other to make the cut.

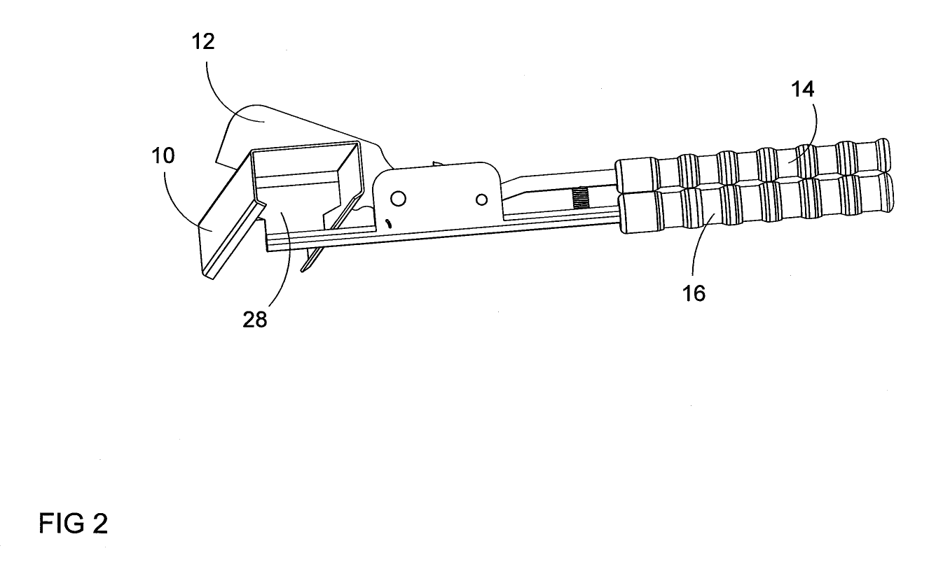

FIG. 2 is a schematic illustration of cutting a metal profile, according to one embodiment of the present invention.

According to one embodiment of the present invention, a blade 28 is inserted into the internal cavity of a metal profile 10, for the cutting of the metal profile. Then, for cutting the metal profile to a desired length, the user moves first handle 14 against second handle 16, causing the closing of upper blade 12 against profile blade 28. By moving one against the other, the upper blade 12 and the profile blade 28 cut the metal profile 10 that is placed in between them. The metal profile 10 that is placed in between upper blade 12 and profile blade 28 is cut in a straight line, crossing the planes of metal profile 10.

According to one embodiment of the invention, the shape of profile blade 28 is adapted to the shape of a metal profile 10. The adapted shape of profile blade 28 keeps the metal profile 10 in its place while it is cut. The shape of profile blade 28 is adapted to the metal profile 10 that is to be cut, and it generally complies with the widespread standards used for such metal profiles. In the case wherein there is a need to cut a metal profile 10 of a certain shape, a specific profile blade 28 that fits the metal profile 10 is to be chosen. Profile blade 28 can be replaced with another profile blade that is adapted to the shape of the metal profile 10 that is needed to be cut.

According to one embodiment of the invention, profile blade 28 is complementary to the internal shape of metal profile 10. Profile blade 28 is inserted into the cavity of metal profile 10 to be cut. By moving first handle 14 and second handle 16 one toward the other, upper blade 12 and profile blade 28 move one against the other, while the profile blade 28 supports the metal profile 10. The insertion of the complementary shape of profile blade 28 into the internal shape of metal profile 10 gives the needed support to the metal profile 10 and holds it in its place while it is cut.

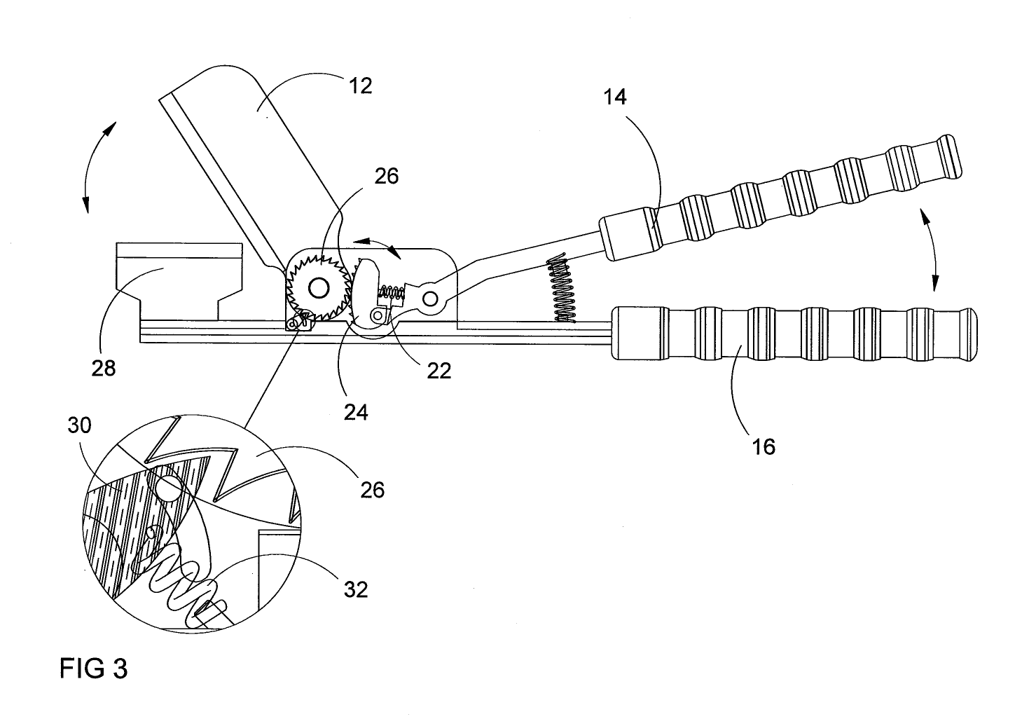

According to another embodiment of the present invention, for the cutting of metal profile 10, the user presses the first handle 14 and the second handle 16 several times, each time closing first handle 14 and second handle 16, and then opens first handle 14 and second handle 16, to then close them again. With each of these manual operations of closing first handle 14 and second handle 16, the upper blade 12 and the profile blade 28 are closing to make the cut in the metal profile 10. A ratchet mechanism (shown in FIG. 3) transmits the pressing power on first handle 14 and second handle 16 to the opposite upper blade 12 and profile blade 28, each time the user closes the two handles, thereby gradually causing upper blade 12 and profile blade 28 to cut the metal profile 10. According to this embodiment, each time first handle 14 and second handle 16 are closed, upper blade 12 and profile blade 28 are moving one against the other in a fragmented movement, thereby cutting the metal profile 10. By repetitions of closing and opening first handle 14 and second handle 16, upper blade 12 and profile blade 28 cut a straight line across the planes of the metal profile 10, through a transmission of manual power by the ratchet mechanism.

FIG. 3 is a schematic illustration of an apparatus for cutting metals with a ratchet mechanism, according to one embodiment of the present invention.

According to one embodiment of the present invention, the apparatus for cutting metals has a ratchet mechanism. The ratchet mechanism shown in FIG. 3 includes: a gear 26, a pawl 30 attached to a spring 32, and a pinion 24 attached to a spring 22. The ratchet mechanism of the apparatus for cutting metals allows continuous rotary motion in only one direction, while preventing motion in the opposite direction.

According to one embodiment of the present invention, the ratchet mechanism consists of a round gear 26 with teeth, and a pivoting, spring-loaded finger called pawl 30 that engages the teeth of gear 26. The teeth of gear 26 are uniform but asymmetrical, with each tooth having a moderate slope on one edge and a much steeper slope on the other edge. When the teeth of gear 26 are moving in the unrestricted (i.e., forward) direction, the pawl 30 easily moves up and over the gently sloped edges of the teeth, with a spring 32 forcing it into the depression between the teeth as it passes the tip of each tooth. When the teeth of gear 26 move in the opposite (backward) direction, however, the pawl 30 will catch against the steeply sloped edge of the first tooth it encounters, thereby locking it against the tooth, and preventing any further motion in that direction.

According to one embodiment of the present invention, in the ratchet mechanism of the apparatus for cutting metals, the teeth of gear 26 mesh with another toothed part, pinion 24, in order to transmit torque, preferably with teeth on gear 26 of identical shape, and also with that shape (or at least width) on pinion 24. The meshing between the teeth of gear 26 and the teeth of pinion 24 prevents slipping.

According to one embodiment of the present invention, the transmission of torque from pinion 24 to gear 26 allows for the transmission of the force operated on first handle 14 and second handle 16 to the closing of upper blade 12 and profile blade 28. The ratchet mechanism of the apparatus for cutting metals prevents the movement in the restricted backwards direction, and therefore the opening of upper blade 12 and profile blade 28 during the opening of first handle 14 and second handle 16. Based on the mechanical operation of that ratchet mechanism, the user of the apparatus for cutting metals can alternately close and open first handle 14 and second handle 16, without thereby causing upper blade 12 and profile blade 28 to open. In this way, the closing of first handle 14 and second handle 16 results in the transmission of the force put on the handles to the blades, thereby cutting the metal profile 10, whereas the opening of the handles does not open upper blade 12 and profile blade 28.

According to one embodiment of the present invention, the ratio between pinion 24 and gear 26 determine the output of the force. The ratio between the number of gear 26 teeth and the number of pinion 24 teeth may decide the output power. The power can be calculated from the ratio of the number of teeth on gear 26 and the number of teeth on pinion 24, which can show a measure of the mechanical advantage. The mechanical advantage of the pair of meshing parts, gear 26 and pinion 24, can be calculated given the distances between the teeth and the pivots of the meshing parts. The longer the distance between the teeth of pinion 24 and the pivot of pinion 24, compared with the distance between the teeth of gear 26 and the pivot of gear 26, the stronger the output force. The radius of gear 26 can be changed to increase the mechanical advantage. By choosing a smaller radius for gear 26, an increase in the output force can be gained. By changing gear 26 to a gear with a smaller radius, the operator of the apparatus for cutting metals can increase the power of the closing of upper blade 12 and profile blade 28. Increased closing power of upper blade 12 and profile blade 28 will result in improved cutting power for cutting thicker metal profiles.

As first handle 14 is pressed downward toward second handle 16, the exceeding part from the pivot in first handle 14 toward pinion 24, moves pinion 24 in the upward direction. The movement of pinion 24 moves gear 26, which is connected to upper blade 12. The resulting rotation of gear 26 moves upper blade 12 in the direction of profile blade 28, thereby enabling the cutting of a metal profile 10.

In order to open upper blade 12 after the cutting of metal profile 10, a user may pull pawl 30 away from gear 26, thereby enabling the lifting of upper blade 12, as now the upward movement of upper blade 12 is unrestricted by the ratchet mechanism.

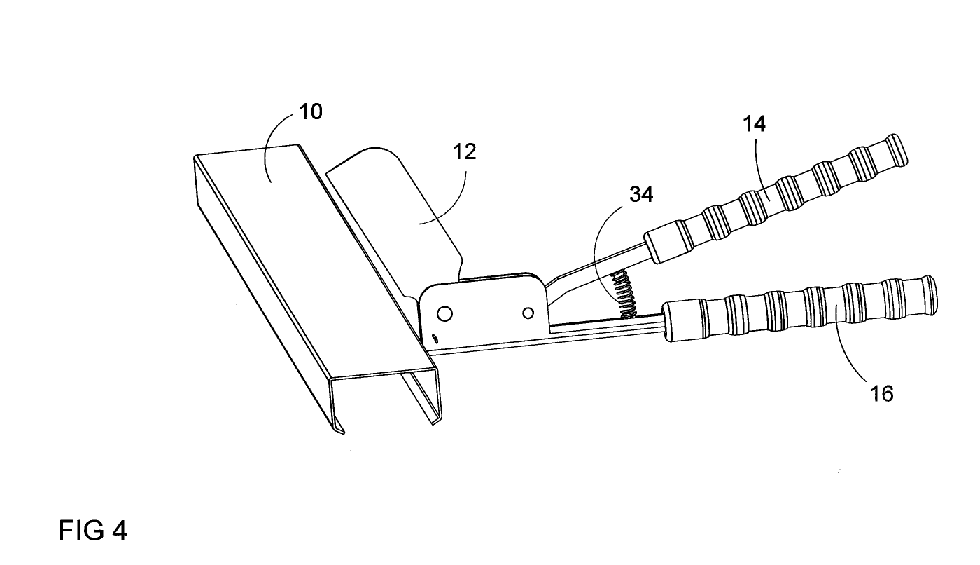

FIG. 4 is a schematic illustration of cutting a metal profile, according to one embodiment of the present invention.

According to one embodiment of the present invention, metal profile 10 is placed on top of profile blade 28, for cutting of metal profile 10 at a desired place in a straight line. The user of the apparatus for cutting metals according to the invention grabs both handles with his two hands and presses first handle 14 in the direction of second handle 16. Spring 34 for opening handles 14 and 16 connects first handle 14 with second handle 16. When the user presses first handle 14 and second handle 16, spring 34 is compressed. As spring 34 compresses, it stores mechanical energy. The mechanical energy stored in spring 34 is used for opening first handle 14 and second handle 16 after the user releases his press on the handles. When spring 34 stretches back, the force it exerts opens the handles as it lifts back first handle 14. While first handle 14 and second handle 16 open as a result of the exertion of spring 34, upper blade 12 and profile blade 28 do not open, as the ratchet mechanism prevents the backward movement of gear 26, and of upper blade 12 connected to it.

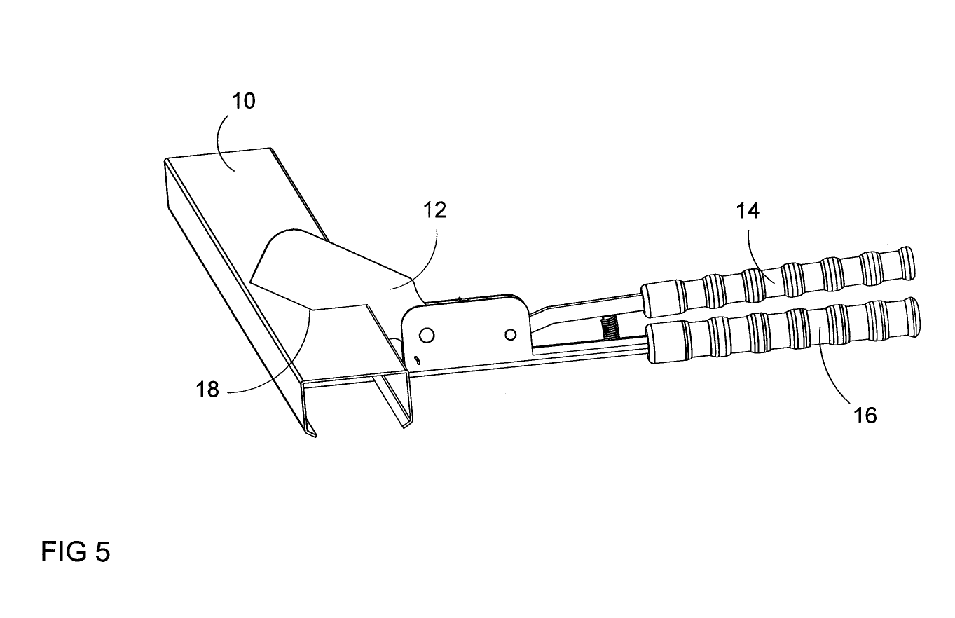

FIG. 5 is a schematic illustration of cutting a metal profile, according to one embodiment of the present invention.

According to one embodiment of the invention, as the user presses on the handles 14 and 16, the upper blade 12 descends toward profile blade 28, and cuts the metal profile 10. In this way, as upper blade 12 and profile blade 28 are closing, they move against each other as they make a cut 18 at the profile 10.

The adapted shape of profile blade 28 to the metal profile 10 keeps the metal profile in its place while it is cut. The cut 18 of metal profile 10 is going along beside the edge of profile blade 28 that is adapted to the shape of the metal profile 10 that is being cut, and is placed on it. The profile blade 28 also provides a mechanical support to the metal profile 10 while the profile is cut 18.

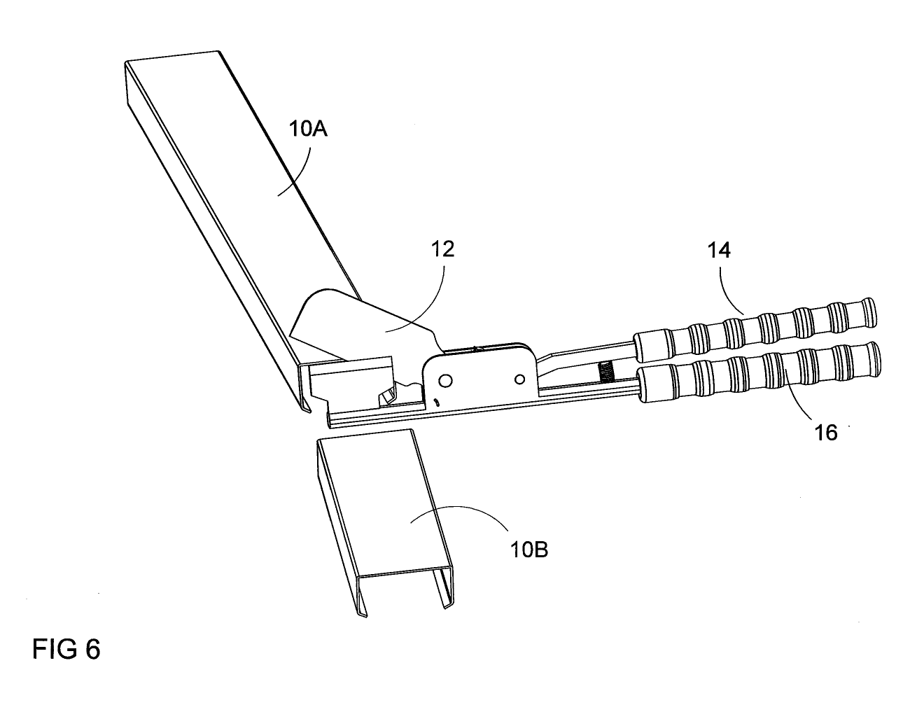

FIG. 6 is a schematic illustration of a metal profile cut into two parts with an apparatus for cutting metals, according to one embodiment of the present invention.

According to one embodiment of the invention, as upper blade 12 and profile blade 28 are closed, the metal profile 10 that is placed in between the blades is cut. The blades 12 and 28 are passing each other as upper blade 12 descends and makes the cut of the metal profile 10. The metal profile 10 is cut into two different parts, 10A and 10B. The desired first part 10A of the cut profile has the required measurement, and is ready for use in the construction of a drywall.

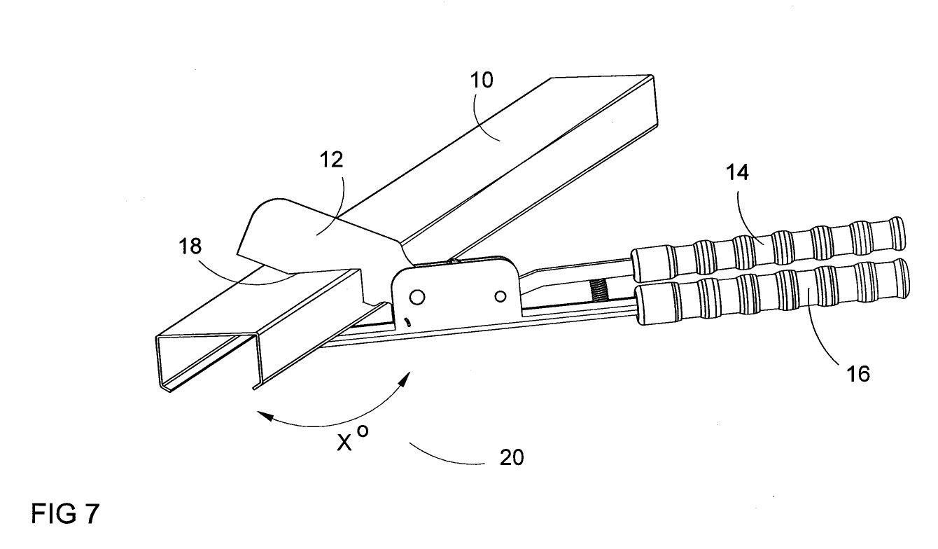

FIG. 7 is a schematic illustration of cutting a profile in a diagonal line with an apparatus for cutting metal profiles, according to another embodiment of the present invention.

The apparatus for cutting metal profiles may be used to cut a metal profile 10 in a diagonal line.

Sometimes it is necessary to cut a metal profile diagonally, for example, in an angle of 45 degrees. Such a diagonal cut is used for enabling a connection (a joint) of two different metal profiles to a right angle in the construction of a drywall. The connection of the two metal profiles to a right angle is called a miter joint (or, derived from the German language, it is also called “Gehrung”). The apparatus for cutting metal profiles, according to another embodiment of the invention, enables such a diagonal cut of metal profile 10 (for example, for using the cut profiles in a miter joint). By changing the placement angle 20 of metal profile 10 in relation to the blades 12 and 28, the metal profile can be cut in a diagonal line. If the required angle for the cut of metal profile 10 is 45 degrees, then the angle “X” for the angle of cut 20 would be 135 degrees. (135 degrees is the complementary angle of 45 degrees to a straight angle of 180 degrees).

After the metal profile 10 is placed in an angle “X” for an angle of cut 20, the user closes first handle 14 and second handle 16 to cut the metal profile in a diagonal line. The metal profile 10 is then cut into two parts, with a diagonal line at the edge of the cut. Such a diagonal cut is preferable when a metal profile is used for a miter joint. For example, to cut a metal profile for use in a miter joint, the angle of cut 20 will be 45 degrees (or 135 degrees, which is complementary to a straight angle of 180 degrees). By cutting two required metal profiles to a measured length with an edge that is cut in a diagonal line of 45 degrees, the two profiles can be connected to a miter joint, forming a right angle. Of course, the preferred angle of cut 20 can be different from 45 degrees, as required by the construction for the drywall.

Since the diagonal line is longer, it is preferable to use a longer blade 28, for better addressing the complementary requirement thereof at the diagonal position thereof. In addition, the blade 28, being longer for adapting to the pre-selected angle, such as the 45 degrees, naturally maintains the selected disposition thereof in relation to the profile, during the cutting.

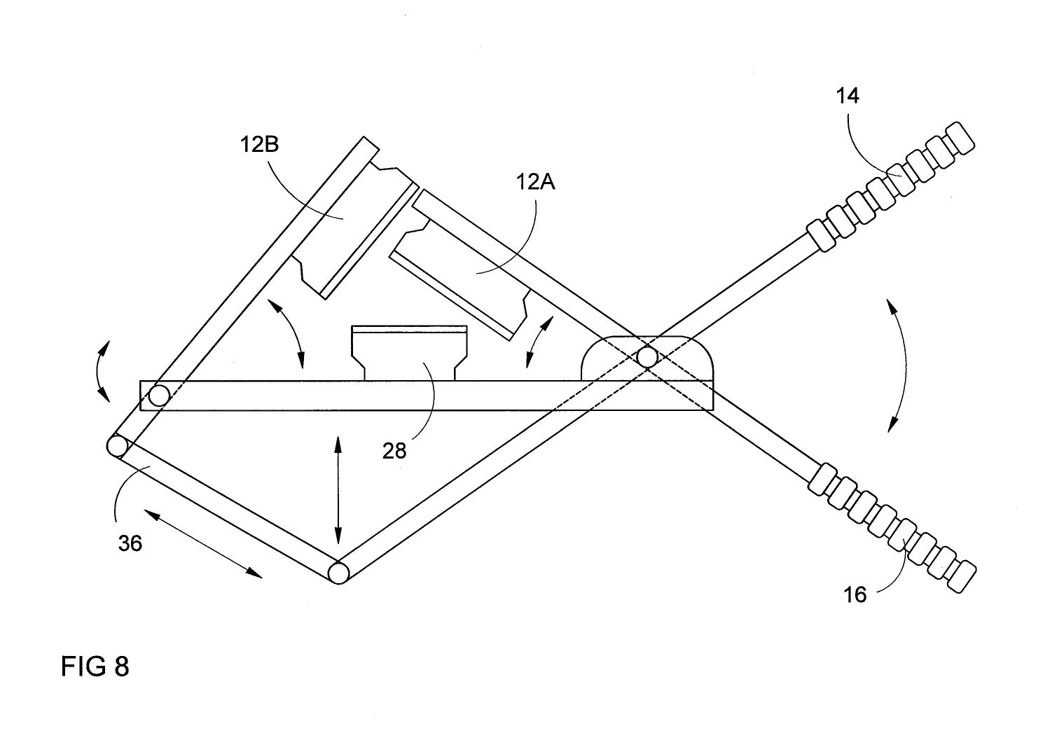

FIG. 8 is a schematic illustration of an apparatus for cutting metals with three blades, according to another embodiment of the present invention.

According to another embodiment of the present invention, the apparatus for cutting metal profiles is having three blades 12A, 12B, and 28. The lower blade is profile blade 28, which is shaped in a complementary shape to metal profile 10. The complementary shape of profile blade 28 allows for the placing of the blade within metal profile 10 that is to be cut. The upper blades 12A and 12B are placed against the profile blade 28, for allowing the moving of upper blades 12A and 12B against the profile blade 28. The placing of two upper blades 12A and 12B against profile blade 28, allows an improved stability of metal profile 10 while it is cut. With the press of the three blades 12A, 12B and 28 on metal profile 10 from three different directions, the cutting of metal profile 10 is facilitated and enhanced by the improved stabilization of the metal profile.

Transmission mechanism 36 enables the transmission of force from first handle 14 and second handle 16 to upper blade 12B. While the user press first handle 14 and second handle 16 one towards the other, both upper blades 12A and 12B moves towards profile blade 28. The simultaneous movements of the blades, achieved by transmission mechanism 36, produce the moving of all three blades 12A, 12B and 28 against one another, to allow for a smooth cut of metal profile 10.

According to another embodiment of the present invention, the apparatus for cutting metal profiles is having more than three blades. With the adding of an additional blade to the three blades 12A, 12B and 28 of FIG. 8, an improved stability of the metal profile and a smoother cut can be achieved. By placing, for example, four blades around metal profile 10 that is to be cut, an efficient cut can be gained with the advantage of a quick operation. A similar mechanism to transmission mechanism 36 enables the simultaneous movements of all blades one towards the other for the making of the cut.

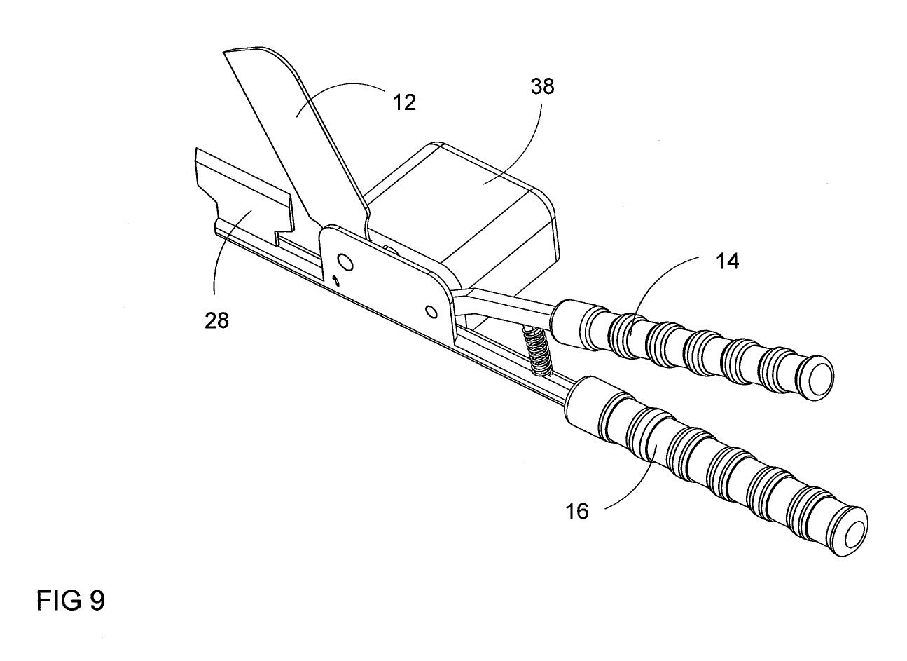

FIG. 9 is a schematic illustration of an apparatus for cutting metals coupled with a motor, according to one embodiment of the present invention.

According to another embodiment of the invention, a motion mechanism 38 or 16 is moving second blade 12, in relation to first blade 28. The motion mechanism for moving second blade 12 in relation to first blade 28 may be second handle 16. In this way, by moving handles 14 and 16 one towards the other, blades 12 and 28 move one against the other, while first blade 28 supports the metal profile 10. Alternatively, the motion mechanism may be a motor 38, for moving blade 12 in relation to blade 28.

According to another embodiment of the invention, transmission mechanism 36 (shown in FIG. 8), is connected to motion mechanism 16 or 38 and to blade 12B. The transmission mechanism 36 transmits the motion between motion mechanism 16 or 38, and blade 12B. In this way, motion mechanism 16 or 38 is moving blade 12B in relation to first blade 28.

According to another embodiment of the invention, the apparatus for cutting metals according to the present invention may be coupled to a motor 38, for moving blades 12 and 28.

According to another embodiment of the invention, motor 38 is connected to the ratchet mechanism for transmitting power to gear 26. The motor 38 is connected to gear 26, thereby transmitting motion from the motor to the gear, for moving the blade that is connected to the gear. When motor 38 is operated by a user, blades 12 and 28 are moving one against the other, for the cutting of a metal profile 10.

According to another embodiment of the invention, motor 38 may be an electric motor, a hydraulic motor, or a pneumatic motor.

In the figures and/or description herein, the following reference numerals (Reference Signs List) have been mentioned:
numeral 10 denotes a metal profile;
numeral 10A denotes a first part of the cut profile;
numeral 10B denotes a second part of the cut profile;
numeral 12 denotes an upper blade;
numeral 12A denotes an upper blade;
numeral 12B denotes an upper blade;
numeral 14 denotes a first handle;
numeral 16 denotes a second handle;
numeral 18 denotes a cut at the profile 10;
numeral 20 denotes an angle of cut;
numeral 22 denotes a spring;
numeral 24 denotes a pinion;
numeral 26 denotes a gear;
numeral 28 denotes a profile blade;
numeral 30 denotes a pawl;
numeral 32 denotes a spring;
numeral 34 denotes a spring for opening handles 14 and 16;
numeral 36 denotes a transmission mechanism; and
numeral 38 denotes a motor.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A handheld apparatus for cutting metals, comprising:
a first blade (28), shaped complementary to the shape of a cavity of a metal profile (10) to be cut, for placing said first blade (28) within the cavity, and maintaining a position of the placing during the cutting;
at least a second blade (12), disposed against said first blade (28), for allowing moving said at least second blade (12) against said first blade (28) and against the metal profile (10) placed therewithin;
a first handle (14) for holding said first blade (28); and
a second handle (16), for moving said at least second blade (12), in relation to said first blade (28) and in relation to the metal profile (10);
thereby moving said blades (12, 28) one against the other, while said first blade (28) supports the metal profile (10);
thereby cutting said metal profile (10).

2. An apparatus for cutting metals according to claim 1, wherein said at least second blade comprises two blades (12A, 12B), each disposed against said first blade (28), for allowing moving said two blades (12A, 12B) against said first blade (28) and against the metal profile (10) placed therewithin.

3. An apparatus for cutting metals according to claim 1, further comprising:
a ratchet mechanism, for allowing a motion only in one direction, while preventing motion in the opposite direction.

4. An apparatus for cutting metals according to claim 3, wherein said ratchet mechanism comprises a gear (26) and a pawl (30) attached to a spring (32),
thereby allowing a continuous rotary motion of said gear (26) in only one direction.

5. An apparatus for cutting metals according to claim 4, wherein said gear (26) is connected to said at least second blade (12),
thereby allowing a motion of said at least second blade (12) only toward the direction of said first blade (28), while preventing a motion in the opposite direction.

6. An apparatus for cutting metals according to claim 4, wherein said apparatus further comprises a pinion (24) meshed with said gear (26), thereby transmitting torque from said pinion (24) to said gear (26) for allowing an increase in the mechanical force applied on said blades (28, 12),
thereby increasing the power of cutting said metal profile (10).

7. An apparatus for cutting metals according to claim 1, wherein said first blade (28) is replaceable for being adapted to various profile shapes.

8. An apparatus for cutting metals according to claim 1, wherein the shape of said first blade (28) is adapted to comply with a selected standard shape of profile.

9. An apparatus for cutting metals according to claim 1, wherein the shape of said first blade (28) is adapted to comply with a selected angle of positioning thereof within the profile,
thereby allowing diagonal cutting of the profile.

10. An apparatus for cutting metals according to claim 2, further comprising:
a transmission mechanism (36), connected to said motion mechanism (16, 38) and to at least one of said two blades (12A, 12B), said transmission mechanism (36) for transmitting motion therebetween,
thereby moving said at least one of said two blades (12A, 12B) in relation to said first blade (28) and against the metal profile (10) placed therewithin.

11. A handheld apparatus for cutting metals, comprising:
a first blade (28), shaped complementary to the shape of a cavity of a metal profile (10) to be cut, for placing said first blade (28) within the cavity, and maintaining a position of the placing during the cutting;
at least a second blade (12), disposed against said first blade (28), for allowing moving said at least second blade (12) against said first blade (28) and against the metal profile (10) placed therewithin;
a first handle (14) for holding said first blade (28); and
a motor (38), for moving said at least second blade (12), in relation to said first blade (28) and to the metal profile (10);
thereby moving said blades (12, 28) one against the other, while said first blade (28) supports the metal profile (10);
thereby cutting said metal profile (10).

12. An apparatus for cutting metals according to claim 11, wherein said motor is selected from a group consisting of: an electric motor, a hydraulic motor, and a pneumatic motor.

13. A method for cutting metals, comprising the steps of:
inserting a first blade (28) into a cavity of a metal profile (10), said first blade shaped complementary to the shape of the cavity of a metal profile (10) to be cut;
moving a second handle (16) towards a first handle (14), for moving a second blade (12) towards second first blade (28) while maintaining a position of the placing of said first blade (28) within the cavity of the metal profile (10) during the cutting;
thereby said second blade (12) moves against said first blade (28) and against the metal profile (10) while said first blade supports said metal profile (10), thereby cutting said metal profile (10).

14. A method for cutting metals according to claim 13, further comprising the step of:
repeating said step of moving said first handle (14) and said second handle (16) one toward the other,
wherein each time releasing said handles (14, 16) and then pressing on said handles (14, 16) again;
wherein a ratchet mechanism allows a motion of said second blade (12) only toward the direction of said first blade (28) while preventing a motion in the opposite direction, thereby moving said blades (12, 28) one against the other in only one direction while the metal profile (10) is placed within said first blade (28).

15. A method for cutting metals according to claim 13, wherein said step of inserting said first blade (28) within the cavity of the metal profile (10) comprises the step of:
placing said first blade (28) diagonally to said metal profile (10);
thereby said cutting of said metal profile (10) comprises cutting said metal profile (10) in a diagonal line.

16. A method for cutting metals according to claim 15, wherein said diagonal placing of said first blade (28) in relation to said metal profile (10) comprises an angle of 45 degrees,
thereby said cutting of said metal profile (10) comprises cutting said metal profile (10)at an angle of 45 degrees,
thereby enabling connecting said cut metal profile (10) in a miter joint with another metal profile.
